(19) United States
(12) Patent Application Publication
(10) Pub. No.: US 2017/0268762 A1
(43) Pub. Date: Sep. 21, 2017

(54) Light Mounting Apparatus

(71) Applicants: Jyoti Gururaj Kathawate, Smyrna, GA (US); Michael Troy Winslett, Fairburn, GA (US)

(72) Inventors: Jyoti Gururaj Kathawate, Smyrna, GA (US); Michael Troy Winslett, Fairburn, GA (US)

(21) Appl. No.: 14/243,094

(22) Filed: Apr. 2, 2014

(51) Int. Cl. F21V 29/00

(52) U.S. Cl. CPC F21V 29/2206; F21V 29/004

(57) ABSTRACT

A light socket configuration originally intended for light sources based on technologies other than light emitting diodes (LEDs) can be upgraded to accommodate an LED light source. The upgraded socket can be backward compatible with the non-LED light sources and thus may accommodate both LED- and non-LED-based light sources. The upgrade can comprise adding heat management technology to the light socket to address heat sensitivity of LED light sources. A structural portion of the socket can be formed from a material that has a relatively high thermal conductivity in order to conduct heat away from the LED light source. The socket may include heat dissipating fins. An associated heat spreader or heat sink can spread, sink, dissipate, or otherwise manage the heat conducted away from the LED light source.

### TECHNICAL FIELD

Embodiments of the technology relate generally to light mounting, and more particularly to a light socket that manages heat generated by an associated light source, such as a thermally sensitive light source that utilizes a light emitting diode (LED) to produce light.

### BACKGROUND

Most conventional light sockets are configured for light sources that are relatively tolerant to heat. For example, typical incandescent and fluorescent light sources operate acceptably with elevated temperature, and thus sockets originally intended for those applications are generally outfitted with little or no thermal management facilities.

Interest is escalating in the utilization of light emitting diodes as an alternative to such conventional light sources. Driving this interest, light emitting diodes offer longevity and efficiency advantages over incandescent and other common approaches to converting electrical energy into luminous energy.

However, light emitting diodes are generally sensitive to the heat that their operation generates. When the thermal energy of operation accumulates, temperature of a light emitting diode can rise, resulting in decreased performance or shortened life. Accordingly, conventional light sockets that lack adequate thermal management facilities are ill matched to light emitting diodes.

Light emitting diode components also typically come in packages that are very different from conventional incandescent light bulbs or fluorescent bulbs. Thus, an additional impediment to broader adoption of light emitting diodes for illumination is the mismatch between the design base of conventional light sources and the light emitting diode format.

Need is evident for improved light sockets. Need is apparent for a light socket offering a level of thermal management suitable for light emitting diodes. Need exists for a light socket that is compatible with conventional light sources as well as with light sources that are based on light emitting diode technology. Need further exists for a light socket that complies with one or more light socket standards or conventions while being suitable for new light emitting diode sources. A capability addressing one or more such needs, or some other related deficiency in the art, would support wider and more cost effective deployment of light emitting diodes for illumination.

### SUMMARY

In one aspect of the disclosure, a light socket comprises an electrically insulating material having a thermal conductivity adequate to support operation of a light emitting diode by conducting heat away from the light emitting diode. For example, the thermal conductivity may be at least 2 W/m· ° K.

In another aspect of the disclosure, a light socket may comply with an industry standard or convention for a conventional, non-LED light source. The light socket can provide sufficient thermal management to support operation of an LED-based light source. For example, the light socket can comprise an electrically insulating material having a thermal conductivity of at least 2 W/m·° K to conduct heat so that the light socket is compatible with the LED-based light source. The electrically insulating material of the socket may be formed into heat dissipating fins, for example.

The foregoing discussion of lighting is for illustrative purposes only. Various aspects of the present technology may be more clearly understood and appreciated from a review of the following text and by reference to the associated drawings and the claims that follow. Other aspects, systems, methods, features, advantages, and objects of the present technology will become apparent to one with skill in the art upon examination of the following drawings and text. It is intended that all such aspects, systems, methods, features, advantages, and objects are to be included within this description and covered by this application and by the appended claims of the application.

### BRIEF DESCRIPTION OF THE FIGURES

Reference will be made below to the accompanying drawings.

FIG. 1 is an illustration of a lighting fixture that includes a light socket and a light emitting diode light source in accordance with some example embodiments.

FIG. 2 is an illustration of a light socket that is thermally managed and into which a light emitting diode light source is mounted in accordance with some example embodiments.

FIGS. 3A and 3B (collectively FIG. 3) are illustrations of a light socket that is thermally managed and that supports a light emitting diode light source in accordance with some example embodiments.

FIG. 4A is an illustration of thermal characteristics of a light socket that is made of ceramic material and that supports a light emitting diode light source in accordance with some example embodiments, while FIG. 4B is a comparative illustration of thermal characteristics of a conventional porcelain light socket. FIG. 4A and FIG. 4B may be collectively referred to as FIG. 4.

FIG. 5 is an illustration of a lighting fixture that is thermally managed and that supports a light emitting diode light source in accordance with some example embodiments.

FIG. 6 is an illustration of a lighting fixture that is thermally managed and that supports a light emitting diode light source in accordance with some example embodiments.

FIG. 7 is an illustration of a lighting fixture that is thermally managed and that supports a light emitting diode light source in accordance with some example embodiments.

FIG. 8 is an illustration of a lighting fixture that is thermally managed and that supports a light emitting diode light source in accordance with some example embodiments.

FIG. 9 is an illustration of a light socket that is thermally managed and that supports a light emitting diode light source in accordance with some example embodiments.

FIG. 10 is an illustration of a light socket that is thermally managed and that supports a light emitting diode light source in accordance with some example embodiments.

FIG. 11 is an illustration of a light socket that is thermally managed and that supports a light emitting diode light source in accordance with some example embodiments.

FIGS. 12A, 12B, and 12C (collectively FIG. 12) are illustrations of a lighting fixture that is thermally managed and that supports a light emitting diode light source in accordance with some example embodiments.

The drawings illustrate only example embodiments and are therefore not to be considered limiting of the embodiments described, as other equally effective embodiments are within the scope and spirit of this disclosure. The elements and features shown in the drawings are not necessarily drawn to scale, emphasis instead being placed upon clearly illustrating principles of the embodiments. Additionally, certain dimensions or positionings may be exaggerated to help visually convey certain principles. In the drawings, similar reference numerals among different figures designate like or corresponding, but not necessarily identical, elements.

### DETAILED DESCRIPTION OF EXAMPLE EMBODIMENTS

A light socket can provide thermal conductivity to conduct heat away from a light source that is mounted to the light socket. An associated heat spreader can receive and spread the heat that is conducted away by the light socket. The resulting heat management can be sufficient to incorporate one or more light emitting diodes in the light source, which may be incorporated in a luminaire.

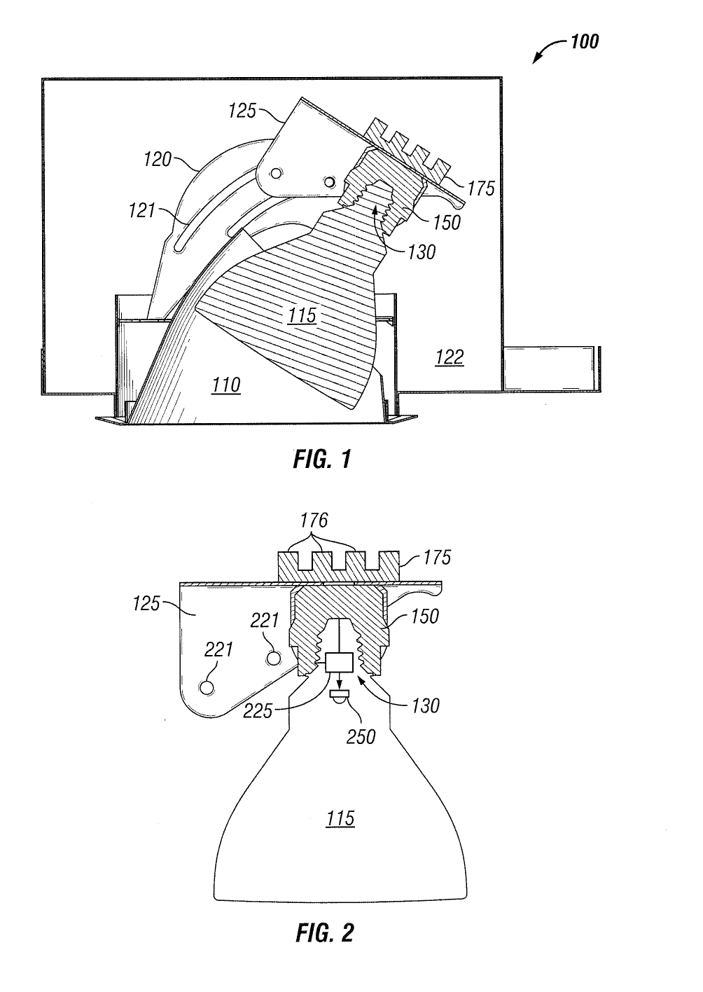

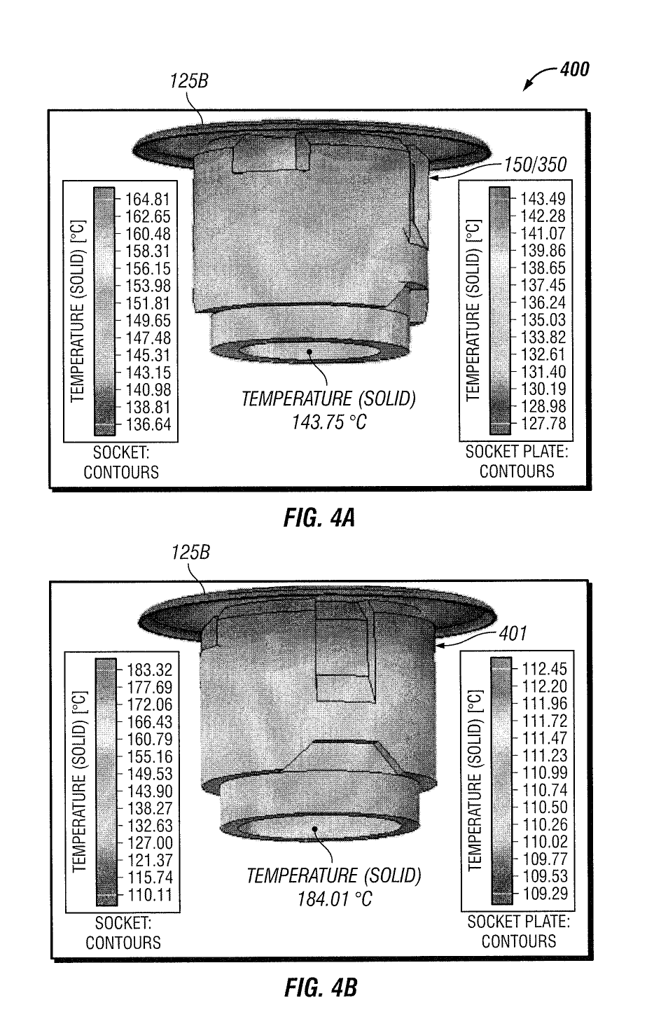

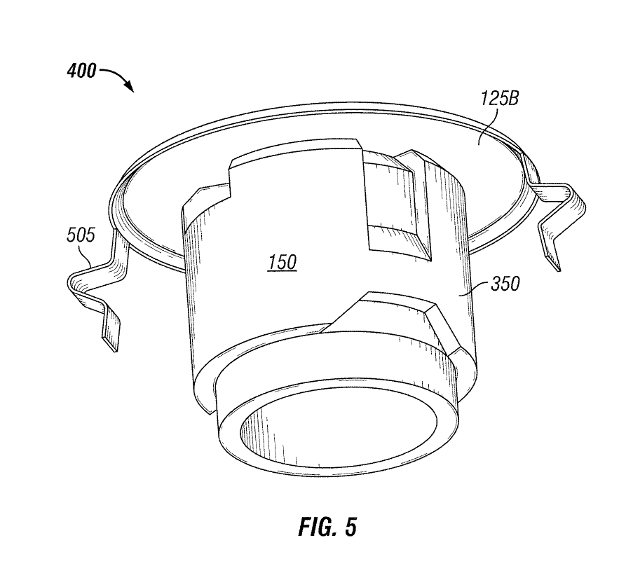

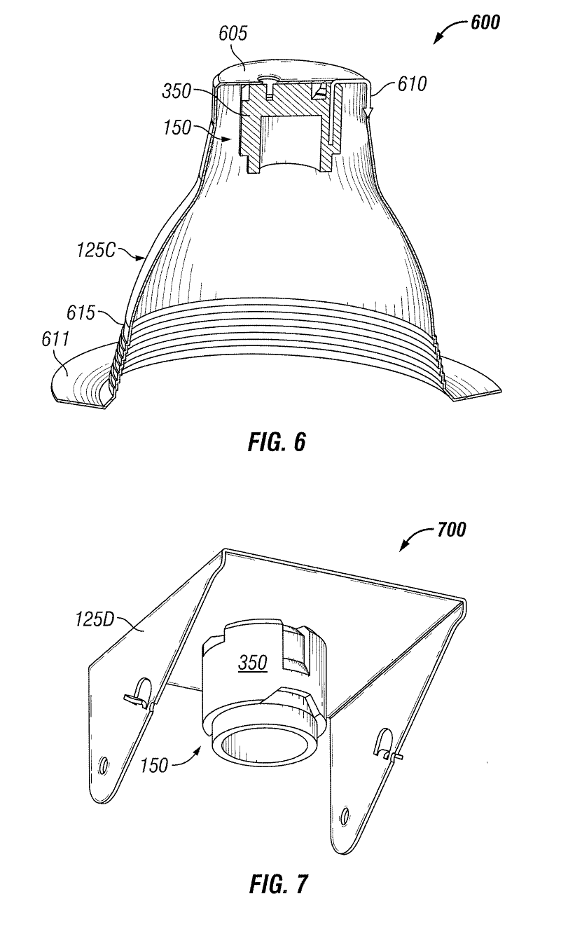

Some representative embodiments will be described more fully hereinafter with example reference to the accompanying drawings. In the drawings, FIGS. 1, 2, and 3 describe a representative lighting fixture that provides sufficient thermal management for operation of an LED-based light source. FIGS. 4 and 5 describe another representative lighting fixture. FIGS. 6, 7, 8, and 12 respectively describe three other representative lighting fixtures that provide sufficient thermal management for operation of an LED-based light source. FIGS. 9, 10, and 11 respectively describe three light sockets that are thermally managed for operation of LED-based light sources.

The technology may, however, be embodied in many different forms and should not be construed as limited to the embodiments set forth herein; rather, these embodiments are provided so that this disclosure will be thorough and complete, and will fully convey the scope of the technology to those appropriately skilled in the art.

Turning now to FIG. 1, this figure illustrates an example lighting fixture 100 that includes a light socket 150 and a light emitting diode light source 115 according to some embodiments. The illustrated lighting fixture 100 thus provides an example of an LED-based luminaire. As will be discussed in further detail below, the illustrated lighting fixture 100 manages heat produced by operating the light emitting diode light source 115 and thus can achieve acceptable performance in terms of component longevity, energy efficiency, and light quality.

The light emitting diode source 115 is mounted in a threaded aperture 130 of the light socket 150. The light emitting diode source 115 and the light socket 150 are in thermal contact with one another. The light socket 150 is mounted to a heat spreader 125. The light socket 150 and the heat spreader 125 are in thermal contact with one another. As illustrated, a heat sink 175 is attached to and in thermal contact with the heat spreader 125.

In some embodiments, the heat sink 175 is optional. In some embodiments, the heat spreader 125 is optional. In some embodiments, the heat sink 175 and the heat spreader 125 are optional.

The term “heat spreader,” as used herein, generally refers to a member that spreads heat, for example a metallic member comprising one area that receives heat and another, larger area that distributes the received heat.

The term “heat sink,” as used herein, generally refers to a device, or one or more features of a device, that absorbs and dissipates excess heat generated by a system. For example, a heat sink could comprise a metal member that functions as a heat exchanger and is designed to conduct heat and radiate heat from a system that is powered by electricity. A heat sink may comprise heat dissipating fins made of metal, ceramic, or some other material having suitable thermal properties, for example.

In the illustrated embodiment, the heat spreader 125 comprises a bracket that is made of metal (for example steel or aluminum) and bent at approximately 90 degrees. Thus, the illustrated bracket is an example embodiment of a heat spreader 125 and may be characterized as an example of a luminaire bracket. The light socket 150 is mounted to the bracket on one side of the bend, and on the other side of the bend, the bracket attaches to a frame 120 of the lighting fixture 100, which includes a housing 122 or enclosure. The frame 120 may be characterized as an example of a luminaire frame. The housing 122 may be mounted above an area to be illuminated, such as in a ceiling of a room, or in another appropriate arrangement for luminaire installation.

The frame 120 comprises adjustment slots 121 along which the light spreader 125 can translate for adjusting angle of light emission. Thus, the lighting fixture 100 can be set to direct light in selected directions.

The lighting fixture 100 further comprises a reflector 110 for directing emitted light. As illustrated, the reflector 110 comprises a hollow, tapered cavity through which light flows. The inner surface 110 of the reflector 110 may be coated with a diffusely reflective paint or other material or may be shiny to promote specular reflection.

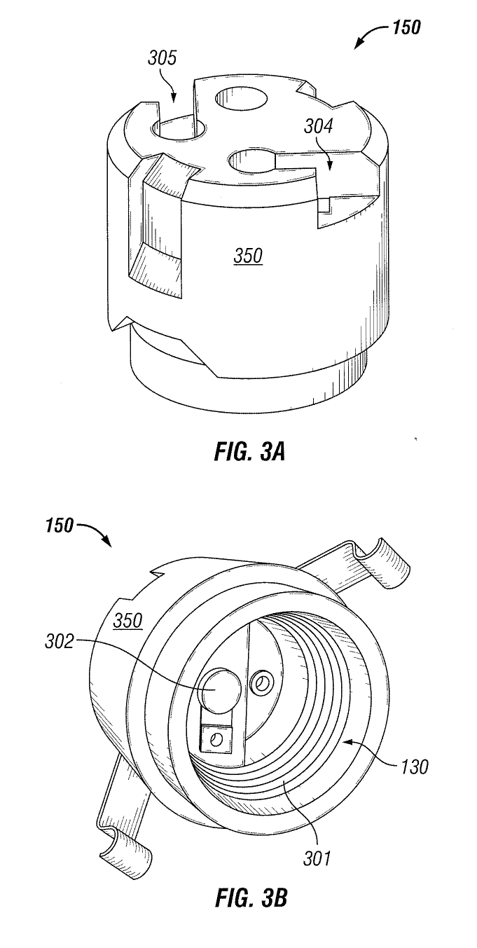

Turning now to FIG. 2, this figure illustrates an example light socket 150 that is thermally managed and in which an example light emitting diode light source 115 is mounted according to some embodiments. More particularly, FIG. 2 illustrates example details for an embodiment of the lighting fixture 100 illustrated in FIG. 1 and discussed above.

As illustrated in FIG. 2, the heat spreader 125 comprises two apertures 221 that align with the adjustment slots 121. A pin or similar member can extend through each aperture 221 and its associated adjustment slot 121, so that the slots 121 function as tracks along which the heat spreader 125 moves.

In the illustrated example embodiment, the light emitting diode light source 115 has geometric features that are consistent with a conventional, incandescent light bulb. Such geometric features may include a smooth exterior, for example. However in some embodiments, the light emitting diode light source 115 may have fins or other features to promote transfer of heat to surrounding air.

As illustrated, the light emitting diode light source 115 comprises an E26 base that provides an electrical connection that is consistent with the conventional, incandescent light bulb.

The light emitting diode light source 115, however, comprises an internal driver circuit 225 and at least one light emitting diode 250. The driver circuit 225 transforms supply electricity to a format suited for driving the light emitting diode 250.

In some embodiments, the light emitting diode 250 comprises one or more discrete light emitting diodes, which may be arranged in an array for example. In some embodiments, the light emitting diode 250 comprises a chip-on-board (COB) light emitting diode.

In operation, the driver circuit 225 and the light emitting diode 250 produce heat. The heat flows through the base of the light emitting diode light source 115 and into the light socket 150. The heat flows from the light socket 150 to the heat spreader 125. The heat spreader 125 spreads the heat. The heat further flows to the heat sink 175, which facilitates transfer to the ambient environment and beyond the lighting fixture 100.

In the illustrated embodiment, the heat sink 175 comprises fins 176 and is mounted to the heat spreader 125 opposite the light socket 150. In some embodiments, the heat sink 175 is mounted away from the light socket 150. In some embodiments, the heat sink 175 is mounted directly on the light socket 150 or otherwise makes physical contact with the light socket 150. The heat sink 175 may comprise aluminum or other appropriate metal, for example.

In some embodiments the heat spreader 125 comprises fins 176 or other surface features or a relief pattern to promote dissipate of heat into the surrounding environment. Accordingly, a heat sink 175 may be incorporated with the heat spreader 125 as a discrete component or directly integrated into the heat spreader 125. Some embodiments may utilize a heat spreader 125 without a heat sink 175.

The driver circuit 225 and the light emitting diode 250 may be located at the base end of the light emitting diode light source 115 to facilitate thermal transfer to the light socket 150. In other words, the driver circuit 225 and the light emitting diode 250 may be located adjacent the light socket 150 when the light emitting diode light source 115 is mounted in the socket 150.

Turning now to FIG. 3, this figure illustrates two views of an example light socket 150 that is thermally managed and that supports a light emitting diode light source 115 according to some embodiments. More specifically, FIG. 3 illustrates an example embodiment of the light socket 150 illustrated in FIGS. 1 and 2 as discussed above.

The illustrated light socket 150 is compatible with conventional E26 light bulbs and thus may be characterized as an E26 light socket. The light socket 150 may further be characterized as an example of an “Edison screw” or “ES” socket.

Electrical contacts 301, 302 within the threaded aperture 130 supply electricity to the light emitting diode light source 115 as illustrated in FIG. 2 and discussed above. Corresponding electrical contacts 304, 305 are located in recesses in the body 350 of the light socket 150, opposite the threaded aperture 130. When wired, the electrical contacts 304, 305 receive electricity from an external power source (typically, but not necessarily alternating current (AC)) for transfer to the electrical contacts 301, 302.

The body 350 of the light socket 150 provides structural support for the light emitting diode light source 115 and electrical insulation between the electrical contact 304 and the electrical contact 305 and between the electrical contact 301 and the electrical contact 302. Additionally, the body 350 of the light socket 150 provides thermal conductivity between the light emitting diode light source 115 and the heat spreader 125 as illustrated in FIGS. 1 and 2. Thus, heat transfers well out of the light emitting diode light source 115 and into the heat spreader 125.

In some example embodiments, the body 350 of the light socket 150 comprises a material having a thermal conductivity that is at least 2 W/m· ° K. In some example embodiments, the body 350 of the light socket 150 comprises a material having a thermal conductivity that is at least 10 W/m· ° K. In some example embodiments, the body 350 of the light socket 150 comprises a material having a thermal conductivity that is in a range of approximately 5 W/m· ° K to approximately 10 W/m· ° K. In some example embodiments, the body 350 of the light socket 150 comprises a material having a thermal conductivity that is in a range of approximately 20 W/m· ° K to approximately 30 W/m· ° K.

In an example embodiment, the body 350 of the light socket 150 is made from a material that has a higher thermal conductivity than porcelain. In some example embodiments, the body 350 of the light socket 150 comprises a thermally conductive ceramic, such as alumina/aluminum oxide, beryllium oxide, or other appropriate material.

In some example embodiments, the body 350 of the light socket 150 comprises thermally conductive plastic material. For example, the body 350 can comprise a thermally conductive plastic material available from DSM Engineered Plastics of Singapore under the trade identifier STANYL TC 501, or a thermally conductive plastic material available from Saudi Basic Industries Corporation of Riyadh, Saudi Arabia under the trade identifier Sabic LNP KONDUIT compound. The body 350 may have thermal conductivity in a range of approximately 2 W/m· ° K to approximately 50 W/m· ° K, for example. In some embodiments, the electrical contacts 301, 302 can be insert molded into the thermally conductive plastic during an injection molding process. In some embodiments, the electrical contacts 301, 302 can be mechanically fastened.

Turning now to FIG. 4, FIG. 4A illustrates example thermal characteristics of a light socket 150 made of ceramic material supporting a light emitting diode light source 115 (not shown in FIG. 4) according to some embodiments, while FIG. 4B illustrates comparative thermal characteristics of a conventional porcelain light socket 401. The light socket 150 illustrated in FIG. 4A can be an embodiment of the light socket 150 illustrated in FIGS. 1, 2, and 3 and will be discussed in that example context, without limitation.

As illustrated in FIG. 4A, the body 350 of the light socket 150 is attached to a heat spreader 125B to form a lighting fixture 400 that can comprise a luminaire. The heat spreader 125B is in the example form of a concave sheet of metal, with the light socket 150 mounted in the depression resulting from the concavity. The conventional porcelain light socket 401 is likewise attached to a heat spreader 125B. The conventional porcelain light socket 401 has a thermal conductivity of approximately 1.0 W/m· ° K, while the ceramic light socket 150 has a thermal conductivity of approximately 35 W/m· ° K.

The temperature gradients illustrated in FIGS. 4A and 4B are computer generated models of heat transfer. As illustrated by the gradients, the light socket 150 made of ceramic transfers heat to the heat spreader 125 and away from the light emitting diode 250 (see FIG. 2) substantially more effectively than the light socket 401 made of porcelain. With the improved thermal management, the light socket 150 supports light emitting diode operation.

Turning now to FIG. 5, this figure illustrates an example lighting fixture 400 that is thermally managed and that supports a light emitting diode light source 115 (not shown in FIG. 5) according to some embodiments. The lighting fixture 400 is consistent with the embodiment illustrated in FIG. 4A, as the lighting fixture 400 comprises the heat spreader 125B and the light socket 150 formed from ceramic material. However, as configured in FIG. 5, the lighting fixture 400 includes a spring clip 505 to facilitate mounting.

Turning now to FIG. 6, this figure illustrates an example lighting fixture 600 that is thermally managed and that supports a light emitting diode light source 115 (not shown in FIG. 6) according to some embodiments. The lighting fixture 600 may be installed in a ceiling aperture or otherwise recessed, for example.

The example lighting fixture 600 illustrated in FIG. 6 in cutaway view, comprises a heat spreader 125C embodied in the example form of luminaire lighting trim, specifically a tapered cavity from which light emits into an area to be illuminated. The illustrated example heat spreader 125C can be formed from a thin sheet of metal, for example aluminum, or from thermally conductive plastic. A lip 611 facilitates recessed mounting. The interior surface of the heat spreader 125 can be coated with diffusely reflective paint or otherwise treated for an optical effect.

The light socket 150 is mounted to a flat area 605 at the narrow end of the tapered heat spreader 125C, which is at the bottom of the concavity. In operation, the body 350 of the light socket 150 receives heat associated with converting electricity into light. The heat flows up the body 350 of the light socket 150, across the flat area 605 of the heat spreader 125C, and down towards the lip 611, for example along the illustrated thermal path 610. A pattern of surface features 615 in the heat spreader 125C helps transfer the heat to the surrounding environment/air.

Turning now to FIG. 7, this figure illustrates an example lighting fixture 700 that is thermally managed and that supports a light emitting diode light source 115 (not shown in FIG. 7) according to some embodiments. In the example embodiment lighting fixture 700 of FIG. 7, a heat spreader 125D is embodied in a U-shaped bracket that may be mounted as an element of a larger lighting fixture/luminaire.

The body 350 of the light socket 150 is mounted to the base of the U-shaped bracket/heat spreader 125D. In operation, heat flows out of the body 350 of the light socket 150 and is spread by the heat spreader 125D.

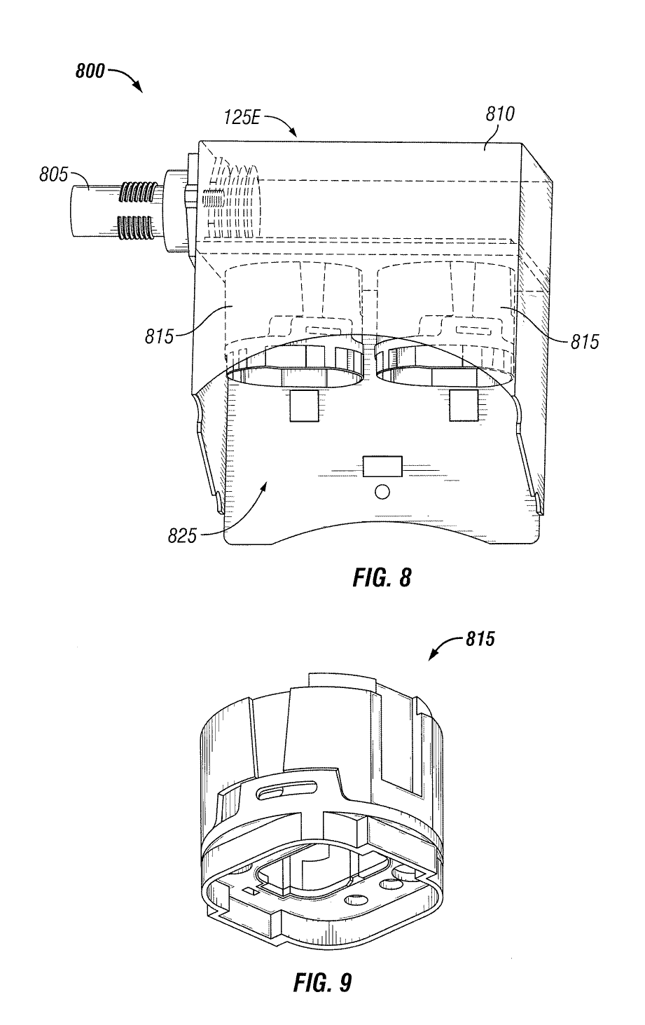

Turning now to FIGS. 8 and 9, FIG. 8 illustrates an example lighting fixture 800 that is thermally managed and that supports a light emitting diode light source (not shown in FIG. 8 or 9) according to some embodiments. FIG. 9 illustrates an example light socket 815, for the lighting fixture 800, that is thermally managed and that supports the light emitting diode light source according to some embodiments.

The illustrated lighting fixture 800 comprises a heat spreader 125E embodied as a wall-mountable housing that includes a junction box section 810 coupled to an electrical conduit 805. Two light sockets 815 are mounted in a cavity section of the heat spreader 125E, so that the heat spreader 125E receives and spreads heat associated with LED operation. The illustrated light sockets 815 are 4-PIN CFL sockets but utilize ceramic and/or plastic materials that provide high heat conductivity as discussed above.

Accordingly, the light sockets 815 are compatible with 4-PIN compact fluorescent light bulbs but provide sufficient thermal conductivity for operation of light emitting diodes. A light emitting diode light source can thus be packaged to have a 4-PIN CFL base, mounted to the light socket 815, and operated as a luminaire.

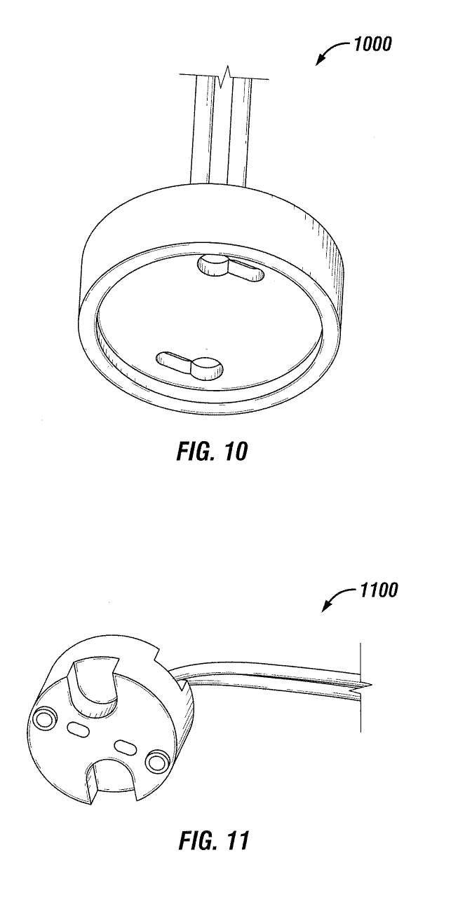

Turning now to FIG. 10, this figure illustrates an example light socket 1000 that is thermally managed and that supports a light emitting diode light source 115 (not shown in FIG. 10) according to some embodiments. The illustrated light socket 1000 comprises a GU24 socket base and may be incorporated in various luminaires.

The light socket 1000 is made of ceramic and/or plastic material having a high thermal conductivity to provide thermal management for operating one or more light emitting diodes as discussed above. In some embodiments, the light socket 1000 is combined with a heat spreader 125 and/or a heat sink 175 for enhanced thermal management as discussed above.

Turning now to FIG. 11, this figure illustrates an example light socket 1100 that is thermally managed and that supports a light emitting diode light source 115 (not shown in FIG. 11) according to some embodiments. The illustrated light socket 1100 comprises a GX5.3 socket base and may be incorporated in various luminaires.

The light socket 1100 is made of ceramic and/or plastic material having a high thermal conductivity to provide thermal management for operating one or more light emitting diodes as discussed above. In some embodiments, the light socket 1100 is combined with a heat spreader 125 and/or a heat sink 175 for enhanced thermal management as discussed above.

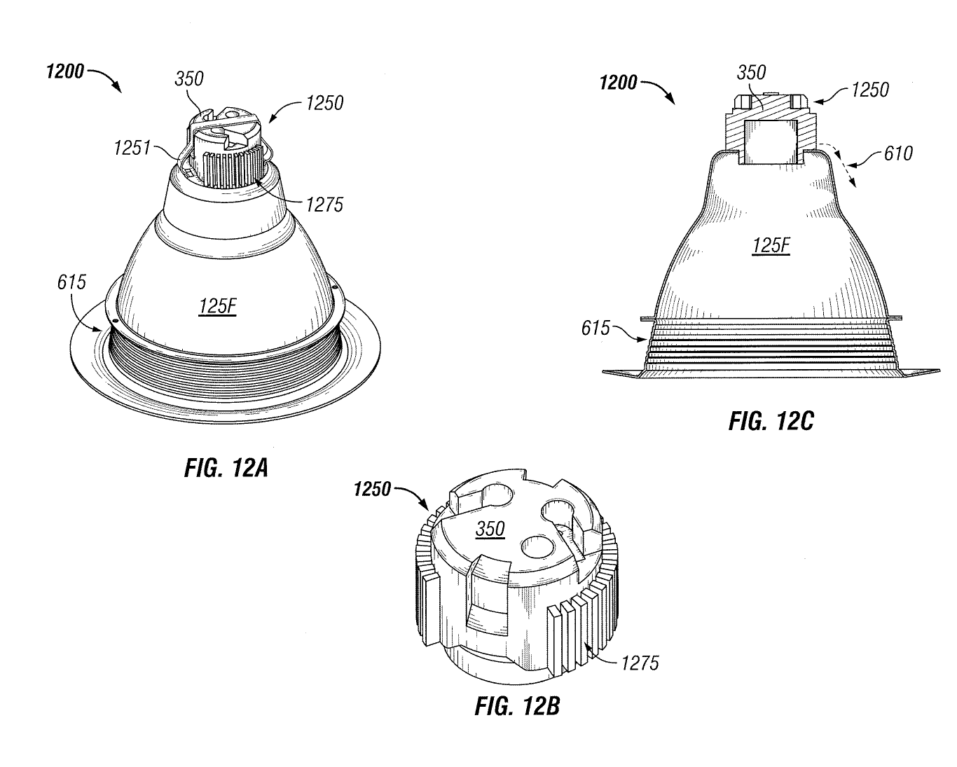

Turning now to FIG. 12, this figure illustrates an example lighting fixture 1200 that is thermally managed and that supports a light emitting diode light source 115 (not shown in FIG. 12) according to some embodiments. The example lighting fixture 1200 illustrated in FIG. 12 comprises a heat spreader 125F in the form of a tapered cavity from which light emits into a room or other space to be illuminated. In some embodiments, the interior surface of the heat spreader 125F can be diffusely or specularly reflective. As illustrated, the example heat spreader 125F, which can be made of metal or other material having suitable heat conductive properties, comprises a pattern of features 615 that help transfer heat to the surrounding environment.

A light socket 1250 is mounted at the narrow end of the heat spreader 125F via a retention clip 1251. Embodiments of the light socket 1250 may comprise ceramic or thermally conductive plastic material, for example. In the illustrated embodiment, the body 350 of the light socket 1250 comprises heat sink fins 1275 that dissipate heat and may be characterized as heat dissipating fins.

In operation, the body 350 of the light socket 1250 receives heat associated with converting electricity into light. The thermal path 610 of heat flowing from the body 350 of the light socket 1250 includes the heat sink fins 1275 and the heat spreader 125F, which includes features 615 that dissipate heat.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of this application. Although specific terms are employed herein, they are used in a generic and descriptive sense only and not for purposes of limitation.

1. An apparatus comprising:
an Edison screw light socket comprising:
a body that comprises:
a front side into which an aperture is formed to receive a threaded light source;
a rear side; and
a side portion that circumscribes the aperture and extends between the front side and the rear side and that has a thermal conductivity of not less than 2 W/m· ° K; and
a first electrical contact disposed adjacent a back of the aperture and a second electrical contact disposed adjacent a side of the aperture for supplying electricity to the threaded light source when the Edison screw light socket has received the threaded light source, wherein the side portion electrically insulates the first electrical contact from the second electrical contact; and
a metallic member attached to and in thermal contact with the rear side of the body.

2. The apparatus of claim 1, wherein the body of the Edison screw light socket further comprises heat sink fins.

3. The apparatus of claim 1, wherein the metallic member comprises a mounting bracket for a luminaire.

4. The apparatus of claim 1, wherein the metallic member comprises a pattern of surface features that promote transfer of heat to a surrounding environment.

5. The apparatus of claim 1, wherein the apparatus further comprises a heat sink,
wherein the metallic member comprises a bracket adjoining the heat sink, and
wherein the bracket is disposed between the heat sink and the Edison screw light socket.

6. The apparatus of claim 1, wherein the body of the Edison screw light socket comprises alumina.

7. The apparatus of claim 1, wherein the body of the Edison screw light socket comprises beryllium oxide.

8. The apparatus of claim 1, wherein the body of the Edison screw light socket comprises ceramic material.

9. The apparatus of claim 1, wherein the body of the Edison screw light socket comprises plastic having the thermal conductivity, and
wherein the first and second electrical contacts are insert molded in the plastic or mechanically fastened.

10. The apparatus of claim 1, wherein the body further comprises a lateral portion disposed between the front side of the body and the rear side of the body,
wherein the metallic member comprises:
a first portion adjoining the rear side of the body;
a second portion that is adjacent the first portion and that extends alongside and circumferentially around the lateral portion of the body; and
a third portion that adjoins the second portion, that tapers out relative to the aperture, and that comprises a diffusely reflective surface.

11. A system for mounting a light source comprising:
an Edison screw socket that comprises a cavity configured to receive and supply electricity to the light source, the Edison screw socket comprising an electrically insulating material that circumscribes the cavity and that has a thermal conductivity of at least 2 W/m· ° K; and
a heat spreader that is adjoining and in thermal communication with the electrically insulating material and that extends from a rear of the Edison screw socket.

12. The system of claim 11, wherein the electrically insulating material comprises a ceramic,
wherein the ceramic provides a thermal conductivity of at least 10 W/m· ° K, and
wherein the Edison screw socket comprises heat sink fins.

13. The system of claim 11, wherein the Edison screw socket is further configured to receive and supply electricity to an incandescent light source,
wherein the light source comprises a light emitting diode based light source having higher thermal sensitivity than the incandescent light source, and
wherein the thermal conductivity and the heat spreader are operative to satisfy the higher thermal sensitivity of the light emitting diode based light source.

14. The system of claim 11, wherein the Edison screw socket comprises an industry standard socket compatible with non-LED-based light sources, and
wherein the thermal conductivity and the heat spreader provide the Edison screw socket with operability for LED-based light sources.

15. The system of claim 11, wherein the heat spreader comprises metal,
wherein the heat spreader is concave and forms a tapered cavity,
wherein the Edison screw socket is disposed in the tapered cavity, with an interior surface of the tapered cavity oriented towards the Edison screw socket, and
wherein the interior surface of the tapered cavity is diffusely reflective.

16. An apparatus comprising
a light socket that removably receives a lamp and that complies with an industry standard or convention for a non-LED light source and that comprises:
an electrically insulating material having a thermal conductivity of at least 2 W/m· ° K to conduct heat so that the light socket is compatible with an LED-based light source; and
heat dissipating fins that comprise the electrically insulating material.

17. The apparatus of claim 16, wherein the light socket is selected from the group consisting of an E26 socket, a 4 PIN CFL socket, a GU24 socket, and a GX5.3 socket.

18. The apparatus of claim 16, wherein the electrically insulating material comprises thermally conductive plastic in which an electrical contact is insert molded or mechanically fastened,
wherein the apparatus further comprises:
a metallic heat spreader adjoining and in thermal contact with the thermally conductive plastic; and
a metallic heat sink adjoining and in thermal contact with the metallic heat spreader, and
wherein the metallic heat sink comprises a plurality of fins.

19. The apparatus of claim 16, wherein the electrically insulating material comprises a ceramic having a thermal conductivity of at least 10 W/m· ° K;
wherein the apparatus further comprises:
a bracket adjoining and in thermal contact with the ceramic, the bracket comprising a heat spreader; and
a heat sink adjoining and in thermal contact with the bracket, and
wherein the bracket is disposed between the heat sink and the light socket.

20. The apparatus of claim 16, wherein the apparatus further comprises one or more of:
a heat spreader adjoining the light socket for spreading the conducted heat; and
a heat sink disposed behind the socket for managing the conducted heat.
